(19) United States
(12) Patent Application Publication
(10) Pub. No.: US 2025/0333009 A1
(43) Pub. Date: Oct. 30, 2025

(54) PROTECTOR AND WIRE HARNESS

(71) Applicant: Yazaki Corporation, Tokyo (JP)

(72) Inventor: Hiroyuki NISHI, Tochigi (JP)

(73) Assignee: Yazaki Corporation, Tokyo (JP)

(21) Appl. No.: 19/091,185

(22) Filed: Mar. 26, 2025

(30) Foreign Application Priority Data
Apr. 30, 2024 (JP) 2024-073309

(51) Int. Cl. B60R 16/02

(52) U.S. Cl. CPC B60R 16/0215

(57) ABSTRACT

A protector is equipped with a locking portion having a female lock provided on a base (first member), and a male lock including a pair of arm portions provided on a cover (second member), a connecting portion connecting base ends of the pair of arm portions, and a pair of claw portions provided on tip ends of the pair of arm portions, where the male lock is surrounded by the pair of arm portions and the connecting portion and has a deformation allowing space portion that opens toward the base in an assembly direction, and is configured so that the pair of arm portions are elastically deformed toward each other along an axial direction (intersecting direction) toward the deformation allowing space portion as the male lock is inserted into the through hole of the female lock.

### CROSS-REFERENCE TO RELATED APPLICATION(S)

The present application claims priority to and incorporates by reference the entire contents of Japanese Patent Application No. 2024-073309 filed in Japan on Apr. 30, 2024.

### BACKGROUND OF THE INVENTION

### 1. Field of the Invention

The present invention relates to a protector and a wire harness.

### 2. Description of the Related Art

As an example of technology relating to a wire harness protector of the related art, JP 2005-80434 A discloses a protector that includes a first member and a second member that are assembled to each other along an assembly direction to form a wiring space portion through which a wiring member can be inserted, and a locking portion that locks the first member and the second member in a mutually assembled state. The locking portion includes a female lock provided on the first member and having a through hole penetrating along the assembly direction, and a male lock provided on the second member and having a deformation allowing space portion that opens toward an opposite side of the first member in the assembly direction by a pair of arm portions and a connecting portion.

However, the protector described in JP 2005-80434 A has room for further improvement in terms of, for example, performing a fitting operation of the female lock and the male lock more appropriately.

### SUMMARY OF THE INVENTION

The present invention is made in consideration of the above circumstance, and has an object to provide a protector and a wire harness that enable a fitting operation of a female lock and a male lock to be performed more appropriately.

In order to achieve the above mentioned object, a protector according to one aspect of the present invention includes a first member and a second member that are assembled to each other along an assembly direction to form a wiring space portion through which a wiring member is insertable; and a locking portion that locks the first member and the second member in a mutually assembled state, wherein the locking portion includes a female lock provided in the first member and having a through hole penetrating along the assembly direction, and a male lock including a pair of arm portions provided in the second member at an interval from each other along an intersecting direction intersecting the assembly direction, protruding toward the first member along the assembly direction, and inserted into the through hole of the female lock, a connecting portion connecting base ends of the pair of arm portions in the assembly direction, and a pair of claw portions provided at tip ends of the pair of arm portions in the assembly direction, protruding toward sides away from each other along the intersecting direction, and engaged with a peripheral edge portion of the through hole of the female lock, and the male lock is surrounded by the pair of arm portions and the connecting portion, has a deformation allowing space portion that opens toward the first member in the assembly direction, and is configured so that the pair of arm portions are elastically deformable toward each other toward the deformation allowing space portion along the intersecting direction as the female lock is inserted into the through hole.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a wire harness to which a protector according to an embodiment is applied;

FIG. 2 is an exemplary perspective view of the protector according to the embodiment, illustrating a state in which a cover is in an open position;

FIG. 3 is an exemplary cross-sectional view of a locking portion of the protector according to the embodiment, illustrating a state in which a male lock is in a pre-fitting position;

FIG. 4 is an exemplary cross-sectional view of the locking portion of the protector according to the embodiment, illustrating a state in which the male lock is in an intermediate fitting position;

FIG. 5 is an exemplary cross-sectional view of the locking portion of the protector according to the embodiment, illustrating a state in which the male lock is in a fitting completion position; and

FIG. 6 is an exemplary plan view of a protector according to a modification example.

### DETAILED DESCRIPTION OF THE PREFERRED EMBODIMENTS

Hereinafter, embodiment and modification example of the present invention will be described in detail with reference to the drawings. The present invention is not limited to the following embodiment and modification example. Furthermore, components in the following embodiment and modification example include components that are replaceable and easy for a person skilled in the art, or components that are substantially identical.

Moreover, the embodiment and modification example disclosed below include similar components. Therefore, in the following, the similar components are given the same reference numerals and duplicated descriptions are omitted. In this specification, ordinal numbers are used only to distinguish between parts, members, regions, positions, directions, and the like and do not indicate order or priority.

### Embodiment

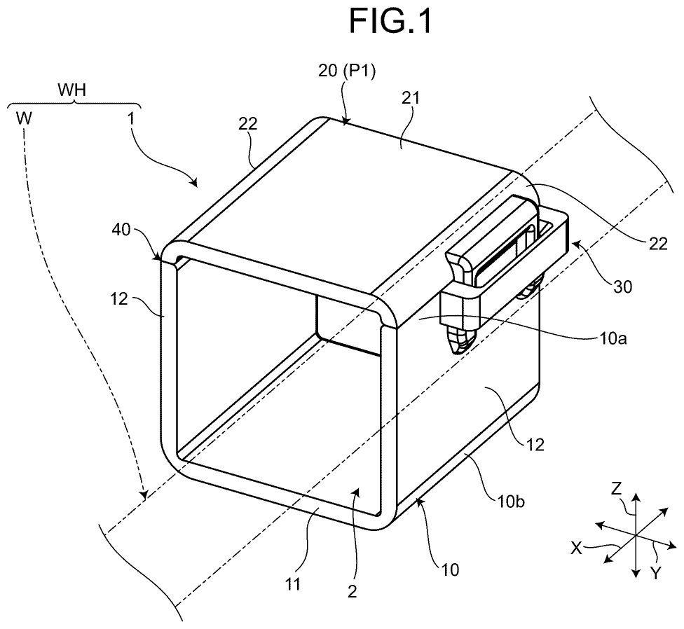

FIG. 1 is a perspective view of a wire harness WH to which a protector 1 according to the embodiment is applied. A protector 1 according to the present embodiment illustrated in FIG. 1 is incorporated into the wire harness WH that is arranged in a vehicle such as an automobile. Here, the wire harness WH is, for example, a component formed by bundling wiring members W used for power supply and signal communication in order to connect each device installed in a vehicle, and connecting the wiring member W to each device using connectors or the like. The wire harness WH of the present embodiment includes the wiring member W having electrical conductivity and the protector 1 that is fitted to the wiring member W. In addition, the wire harness WH may further include various other components such as a grommet, an electric connection box, and a fixing device.

In the following description, of first direction, second direction, and third direction that intersect with each other, the first direction will be referred to as an “axial direction X”, the second direction will be referred to as a “width direction Y”, and the third direction will be referred to as an “assembly direction Z”. Here, the axial direction X, the width direction Y, and the assembly direction Z are substantially perpendicular to each other. The axial direction X typically aligns with an extension direction of the wiring member W, an insertion direction of the wiring member W into the protector 1, a longitudinal direction (extension direction) of the protector 1, and the like. The width direction Y typically corresponds to a width direction of the protector 1, and the like. The assembly direction Z typically corresponds to a height direction (vertical direction) of the protector 1, an assembly direction (stacking direction) of a base 10 and a cover 20 of the protector 1, which will be described below, and the like. In addition, unless otherwise specified, the directions used in the following description are directions when the protector 1 is mounted on the vehicle.

The wiring member W is composed of, for example, a metal rod, an electric wire, a bundle of electric wires, or the like. The metal rod is an electrically conductive rod-shaped member of which the outside is covered with an insulating covering portion. An electric wire has a conductor portion (core wire) made of a plurality of electrically conductive metal wires, the outside of which is covered with an insulating covering portion. The electric wire bundle is a bundle of these electric wires. In the example of FIG. 1, the wire harness WH includes one wiring member W, but the present invention is not limited to this and may include a plurality of wiring members W. The wiring member W extends along the axial direction X.

The protector 1 includes, for example, the base 10 as a first member, the cover 20 as a second member, a locking portion 30, and a hinge portion 40. The base 10 and the cover 20 are assembled to each other along the assembly direction Z to form a wiring space portion 2 through which the wiring member W can be inserted. The base 10 and the cover 20 are formed separately from each other, for example, from synthetic resin, and are integrated with each other by a locking structure (snap fit) using the locking portion 30. The protector 1 is formed into a rectangular tubular shape with the wiring space portion 2 extending along the axial direction X as its center by assembling the base 10 and the cover 20 to each other.

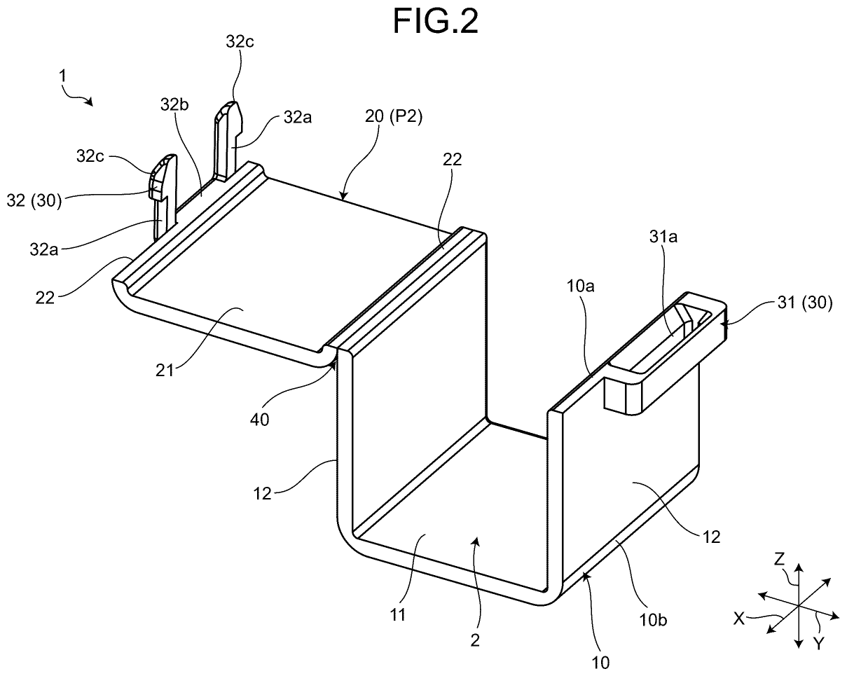

The locking portion 30 locks the cover 20 relative to the base 10 in a closed position P1. The locking portion 30 includes, for example, a female lock 31 (see FIG. 2) in a form of a locking hole provided on the base 10 side, and a male lock 32 in a form of a locking arm provided on the cover 20 side. When the cover 20 is positioned in the closed position P1 relative to the base 10, the locking portion 30 engages the female lock 31 and the male lock 32 along the assembly direction Z, thereby locking the cover 20 in the closed position P1 relative to the base 10.

The hinge portion 40 rotatably connects the cover 20 to the base 10. The hinge portion 40 has a rotation axis extending along the axial direction X, for example. The cover 20 is configured to be rotatable between the closed position P1 (see FIG. 1) that closes the wiring space portion 2 of the protector 1 and an open position P2 (see FIG. 2) that opens the wiring space portion 2 by rotating around the rotation axis of the hinge portion 40. In addition, in FIG. 2, for convenience, a rotation angle of the open position P2 of the cover 20 relative to the closed position P1 is illustrated to be approximately 180 degrees, but this is not limited to this example and may be other angles, such as approximately 90 degrees or approximately 270 degrees.

FIG. 2 is a perspective view of the protector 1, illustrating a state in which the cover 20 is in the open position P2. As illustrated in FIG. 2, the base 10 includes, for example, a base-side bottom wall 11 and a pair of base-side side walls 12. The base-side bottom wall 11 and the pair of base-side side walls 12 are structures for partitioning the wiring space portion 2 of the protector 1. The wiring space portion 2 is a space portion through which the wiring member W is inserted and wired along the axial direction X. The base-side bottom wall 11 is formed, for example, in a flat plate shape and extends along the axial direction X. The base-side bottom wall 11 forms a lower end 10b of the base 10.

The pair of base-side side walls 12 protrude from both ends of the base-side bottom wall 11 in the width direction Y toward the cover 20 in the assembly direction Z and extend along the axial direction X, for example. The pair of base-side side walls 12 include a base-side first side wall located at one end side in the width direction Y, and a base-side second side wall located at the other end side in the width direction Y. The base-side first side wall forms a left end of the base 10, and the base-side second side wall forms a right end of the base 10. In the present embodiment, the above-described hinge portion 40 is provided at an upper end 10a of the base-side first side wall, and the above-described female lock 31 of the locking portion 30 is provided at an upper end 10a of the base-side second side wall.

The cover 20 is configured to include, for example, a cover-side bottom wall 21 and a pair of cover-side side walls 22. The cover-side bottom wall 21 and the pair of cover-side side walls 22, together with the base-side bottom wall 11 and the pair of base-side side walls 12 of the base 10, are structures for partitioning the wiring space portion 2 of the protector 1. The cover-side bottom wall 21 is formed, for example, in a flat plate shape and extends along the axial direction X. The cover-side bottom wall 21 forms an upper end of the cover 20 and covers the wiring space portion 2 from one end side (upper side) in the assembly direction Z.

The pair of cover-side side walls 22 protrude from both ends of the cover-side bottom wall 21 in the width direction Y toward the base 10 in the assembly direction Z and extend along the axial direction X, for example. The pair of cover-side side walls 22 include a cover-side first side wall located at one end side in the width direction Y, and a cover-side second side wall located at the other end side in the width direction Y. The cover-side first side wall forms a left end of the cover 20, and the cover-side second side wall forms a right end of the cover 20. In the present embodiment, the cover-side first side wall is connected to the base-side first side wall via the above-described hinge portion 40, and the cover-side second side wall is provided with the male lock 32 of the above-described locking portion 30.

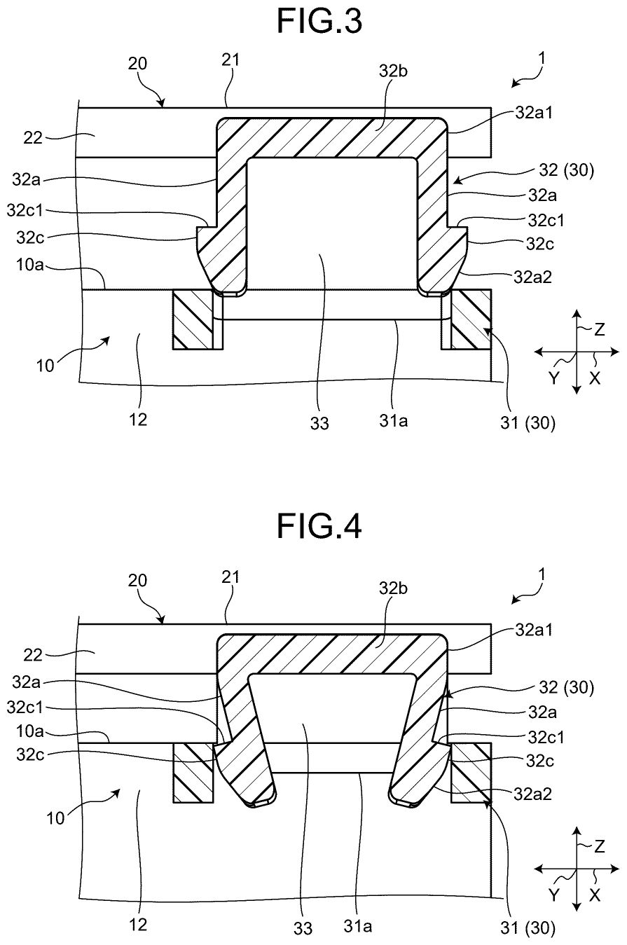

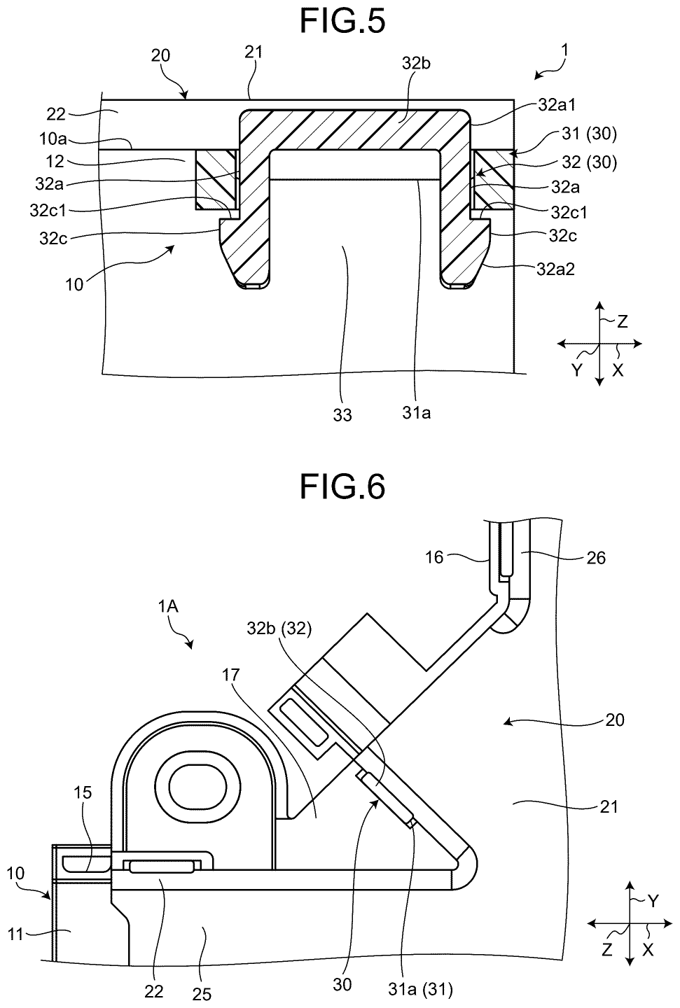

FIG. 3 is a cross-sectional view of the locking portion 30 of the protector 1, illustrating a state in which the male lock 32 is in a pre-fitting position. Also, FIG. 4 is a cross-sectional view of the locking portion 30, illustrating a state in which the male lock 32 is in an intermediate fitting position, and FIG. 5 is a cross-sectional view of the locking portion 30, illustrating a state in which the male lock 32 in a fitting completion position. As illustrated in FIGS. 3 to 5, the female lock 31 includes, for example, a flange-shaped main body portion and a through hole 31a that passes through the main body portion in the assembly direction Z. The main body portion is provided on one of the base-side side walls 12 described above, and protrudes in the width direction Y to an opposite side to the wiring space portion 2. The main body portion is formed in a flange shape at the upper end 10a of one of the base-side side walls 12. The through hole 31a is a locking hole that penetrates the main body portion in the assembly direction Z. The male lock 32 is inserted and fitted into the through hole 31a.

The male lock 32 includes, for example, a pair of arm portions 32a, a connecting portion 32b, and a pair of claw portions 32c. The pair of arm portions 32a are portions of the male lock 32 that protrude from the cover 20 toward the base 10 in the assembly direction Z and are inserted into the through holes 31a of the female lock 31. The pair of arm portions 32a, that is, the male lock 32, are formed integrally with the cover 20 by a flexible bending member such as synthetic resin. In the present embodiment, the pair of arm portions 32a are provided at one cover-side side wall 22 of the cover 20 at an interval from each other along the axial direction X. In the present embodiment, the axial direction X is an example of an intersecting direction that intersects with the assembly direction Z.

The connecting portion 32b is a portion that connects base ends 32a1 of the pair of arm portions 32a of the male lock 32 in the assembly direction Z to each other. The connecting portion 32b is provided, for example, so as to protrude from an outer surface of one of the cover-side side walls 22 of the cover 20. The connecting portion 32b extends along the axial direction X so as to span between the base ends 32a1 of the pair of arm portions 32a.

The pair of claw portions 32c are provided on tip ends 32a2 of the pair of arm portions 32a of the male lock 32 in the assembly direction Z, and are portions that are engaged with a peripheral edge portion of the through hole 31a of the female lock 31. The pair of claw portions 32c, for example, protrude in a claw-like shape from the tip ends 32a2 of the pair of arm portions 32a in the axial direction X toward sides away from each other. The pair of claw portions 32c have locking surfaces 32c1 that face the peripheral edge portion of the through hole 31a in the assembly direction Z, and when the male lock 32 is in the fitting completion position (see FIG. 5), the locking surfaces 32c1 and the peripheral edge portion of the through hole 31a are engaged along the assembly direction Z, thereby locking the cover 20 in the closed position P1 relative to the base 10.

In the present embodiment, the male lock 32 is surrounded by the pair of arm portions 32a and the connecting portion 32b, and includes a deformation allowing space portion 33 that opens toward the base 10 side in the assembly direction Z. That is, the male lock 32 has a substantially U-shaped cross section that opens toward the base 10 side in the assembly direction Z. The deformation allowing space portion 33 allows the pair of arm portions 32a to elastically deform toward each other along the axial direction X when the male lock 32 is inserted into the through hole 31a.

Next, an example of a fitting operation of the female lock 31 and the male lock 32 will be described. First, when the male lock 32 is in the pre-fitting position (see FIG. 3), the through hole 31a of the female lock 31 and the pair of claw portions 32c (tip ends 32a2 of the pair of arm portions 32a) of the male lock 32 are aligned. In the present embodiment, tips of the pair of claw portions 32c are provided with tapered surfaces to facilitate insertion of the male lock 32 into the through hole 31a. The tapered surfaces are inclined so as to widen on both sides in the axial direction X as they approach the base ends 32a1 of the pair of arm portions 32a in the assembly direction Z.

Next, when the male lock 32 is in the intermediate fitting position (see FIG. 4), the pair of claw portions 32c of the male lock 32 are inserted into the through hole 31a of the female lock 31, and the pair of arm portions 32a elastically deform toward each other along the axial direction X. In this case, in the present embodiment, the deformation allowing space portion 33 formed in the male lock 32 allows the pair of arm portions 32a to elastically deform toward each other along the axial direction X, and the tip ends 32a2, which are the free ends of the pair of arm portions 32a, can elastically deform along the axial direction X relatively easily.

When the male lock 32 is in the fitting completion position (see FIG. 5), the pair of claw portions 32c of the male lock 32 climb over the through hole 31a of the female lock 31, causing the pair of arm portions 32a to return to their free state. This causes locking surfaces 32c1 of the pair of claw portions 32c to engage with the peripheral edge portion of the through hole 31a on the base 10 side (lower side) in the assembly direction Z, thereby locking the cover 20 relative to the base 10 in the closed position P1.

As described above, in the protector 1 and wire harness WH of the present embodiment, the male lock 32 is formed by being surrounded by the pair of arm portions 32a and the connecting portion 32b, and has a deformation allowing space portion 33 that opens toward the base 10 (first member) side in the assembly direction Z, and is configured so that the pair of arm portions 32a are elastically deformable toward each other toward the deformation allowing space portion 33 along the axial direction X (intersecting direction) as the male lock 32 is inserted into the through hole 31a of the female lock 31. With this configuration, for example, when the male lock 32 is inserted into the through hole 31a of the female lock 31, the protector 1 and the wire harness WH can relatively easily elastically deform the tip ends 32a2, which are the free ends of the pair of arm portions 32a, along the axial direction X due to the deformation allowing space portion 33. As a result, the female lock 31 and the male lock 32 of the protector 1 and the wire harness WH can be fitted together more appropriately.

In the present embodiment, a case has been illustrated in which the female lock 31 is provided on the base 10 side as the first member, and the male lock 32 is provided on the cover 20 side as the second member, but this example is not limited to this. For example, the female lock 31 may be provided on the cover 20 side as the first member, and the male lock 32 may be provided on the base 10 side as the second member.

### Modification Example

FIG. 6 is a plan view of a protector 1A according to a modification example. The protector 1A illustrated in FIG. 6 has a similar configuration to the protector 1 of the above-described embodiment. Therefore, the protector 1A can obtain the same functions and effects as the above-described embodiment based on the similar configuration.

However, this modification example differs from the above-described embodiment in that the female lock 31 of the locking portion 30 is provided on a plate-shaped portion 17 formed on the outer surface of the base 10, as illustrated in FIG. 6. The plate-shaped portion 17 is, for example, formed by a reinforcing plate for reinforcing a base portion of the base 10 between a base-side first passage portion 15 extending along the axial direction X and a base-side second passage portion 16 extending along the width direction Y. The plate-shaped portion 17 protrudes in a plate shape so as to connect an outer surface of the base-side first passage portion 15 and an outer surface of the base-side second passage portion 16, for example.

In this modification example, the through hole 31a of the female lock 31 is provided in the plate-shaped portion 17, and the periphery of the through hole 31a is blocked by the plate-shaped portion 17. That is, the plate-shaped portion 17 has no openings around the through hole 31a other than the through hole 31a that passes through the plate-shaped portion 17 in the assembly direction Z. In this modification example, the through hole 31a in the plate-shaped portion 17 extends along an inclination direction between the axial direction X and the width direction Y. Therefore, in this modification example, the pair of arm portions 32a (see FIG. 5) of the male lock 32 are provided at an interval from each other along the inclination direction. In this modification example, the inclination direction is an example of an intersecting direction that intersects with the assembly direction Z.

In this modification example, the wire harness WH includes, for example, a trunk portion extending along the axial direction X and branch portions branching from the trunk portion and extending along the width direction Y. The trunk portion is a main portion of the wire harness WH, and is formed by bundling a plurality of wiring members W and is routed in a wiring space portion 2 of the base-side first passage portion 15. The trunk portion may be, for example, a portion of the wire harness WH in which the greatest number of wiring members W are bundled, or may be a portion of the wire harness WH having a largest outer diameter.

The branch portion is a sub-harness portion of the wire harness WH, and is formed by one or more wiring members W branching off from the trunk portion. The branch portion is bent in the width direction Y with respect to the trunk portion extending in the axial direction X, and is routed in a wiring space portion 2 of the base-side second passage portion 16. In this modification example, the cover 20 includes, for example, a cover-side first passage portion 25 covering the wiring space portion 2 of the base-side first passage portion 15 in the base 10, and a cover-side second passage portion 26 covering the wiring space portion 2 of the base-side second passage portion 16.

As described above, in the protector 1A and wire harness WH of this modification example, the through hole 31a of the female lock 31 is provided in the plate-shaped portion 17 which is formed into a plate shape on the outer surface of the base 10 (first member), and an area around the through hole 31a is blocked by the plate-shaped portion 17. With this configuration, the protector 1A and the wire harness WH can, for example, prevent erroneous insertion of the male lock 32 into the through hole 31a of the female lock 31, and the locking portion 30 can be made more compact.

In other words, in this modification example, as in the above-described embodiment, when the male lock 32 is inserted into the through hole 31a of the female lock 31, the male lock 32 itself can elastically deform toward the deformation allowing space portion 33 formed between the pair of arm portions 32a. With this configuration, the protector 1A and the wire harness WH can be configured as described in claim 2 above, and thus there is no need to provide an opening in the plate-shaped portion 17 adjacent to the through hole 31a for deflecting the female lock 31. This makes it possible to prevent erroneous insertion of the male lock 32 and to make the locking portion 30 more compact.

Although the embodiment and modification example of the present invention have been exemplified above, the above embodiment and modification example are merely an example, and are not intended to limit the scope of the invention. The above embodiment and modification example can be implemented in various other forms, and various omissions, substitutions, combinations, and change can be made without departing from the gist of the invention. In addition, the above embodiment and modification example can be implemented by appropriately changing each configuration and specifications such as shape (structure, type, direction, form, size, length, width, thickness, height, number, arrangement, position, material, and the like).

In the protector and wire harness of the present embodiment, the male lock is surrounded by the pair of arm portions and the connecting portion, has a deformation allowing space portion that opens toward the first member in the assembly direction, and is configured so that the pair of arm portions can elastically deform toward each other toward the deformation allowing space portion along the intersecting direction as the male lock is inserted into the through hole of the female lock. With this configuration, in the protector and wire harness, for example, when the male lock is inserted into the through hole of the female lock, the deformation allowing space portion allows the tip ends, which become free ends of the pair of arm portions, to elastically deform along the intersecting direction relatively easily. As a result, the protector and the wire harness have an advantage that a fitting operation between the female lock and the male lock can be performed more appropriately.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A protector comprising:
a first member and a second member that are assembled to each other along an assembly direction to form a wiring space portion through which a wiring member is insertable; and
a locking portion that locks the first member and the second member in a mutually assembled state, wherein
the locking portion includes
a female lock provided in the first member and having a through hole penetrating along the assembly direction, and
a male lock including a pair of arm portions provided in the second member at an interval from each other along an intersecting direction intersecting the assembly direction, protruding toward the first member along the assembly direction, and inserted into the through hole of the female lock, a connecting portion connecting base ends of the pair of arm portions in the assembly direction, and a pair of claw portions provided at tip ends of the pair of arm portions in the assembly direction, protruding toward sides away from each other along the intersecting direction, and engaged with a peripheral edge portion of the through hole of the female lock, and
the male lock is surrounded by the pair of arm portions and the connecting portion, has a deformation allowing space portion that opens toward the first member in the assembly direction, and is configured so that the pair of arm portions are elastically deformable toward each other toward the deformation allowing space portion along the intersecting direction as the female lock is inserted into the through hole.

2. The protector according to claim 1, wherein
the through hole of the female lock is provided in a plate-shaped portion formed in a plate shape on an outer surface of the first member, and a periphery of the through hole is blocked by the plate-shaped portion.

3. A wire harness comprising:
a wiring member having electrical conductivity; and
a protector that is fitted to the wiring member, wherein the protector includes
a first member and a second member that are assembled to each other along an assembly direction to form a wiring space portion through which the wiring member is insertable, and
a locking portion that locks the first member and the second member in a mutually assembled state,
the locking portion includes
a female lock provided in the first member and having a through hole penetrating along the assembly direction, and
a male lock including a pair of arm portions provided in the second member at an interval from each other along an intersecting direction intersecting the assembly direction, protruding toward the first member along the assembly direction, and inserted into the through hole of the female lock, a connecting portion connecting base ends of the pair of arm portions in the assembly direction, and a pair of claw portions provided at tip ends of the pair of arm portions in the assembly direction, protruding toward sides away from each other along the intersecting direction, and engaged with a peripheral edge portion of the through hole of the female lock, and
the male lock is surrounded by the pair of arm portions and the connecting portion, has a deformation allowing space portion that opens toward the first member in the assembly direction, and is configured so that the pair of arm portions are elastically deformable toward each other toward the deformation allowing space portion along the intersecting direction as the female lock is inserted into the through hole.
